(19) United States
(12) Patent Application Publication
(10) Pub. No.: US 2026/0302999 A1
(43) Pub. Date: Oct. 1, 2026

(54) DEVICE AND METHOD FOR CONTROLLING ELECTRIC MOTOR

(71) Applicant: HL MANDO CORPORATION, Gyeonggi-do (KR)

(72) Inventor: Yunjai OH, Gyeonggi-do (KR)

(21) Appl. No.: 19/630,412

(22) Filed: Mar. 26, 2026

(30) Foreign Application Priority Data
Mar. 31, 2025 (KR) 10-2025-0040978
Sep. 8, 2025 (KR) 10-2025-0127692

(51) Int. Cl. H02P 29/50; H02P 29/40

(52) U.S. Cl. CPC H02P 29/50; H02P 29/40; H02P 2205/01

(57) ABSTRACT

A device and a method for controlling an electric motor generate a feed forward voltage in response to a command current received from a controller, generate a compensation voltage based on difference between the command current and the measured current measured by the current sensor for the electric motor, add the feed forward voltage and the compensation voltage to generate a total voltage command, and remove a center frequency component corresponding to the control frequency of the controller from the total voltage command, generated by adding the feed forward voltage and the compensation voltage, to output a motor control voltage command to be applied to the electric motor.

### CROSS-REFERENCE TO RELATED APPLICATIONS

This application claims the priority of Korean Patent Application Nos. 10-2025-0040978 and 10-2025-0127692 filed on Mar. 31, 2025 and Sep. 8, 2025, respectively, in the Korean Intellectual Property Office, the disclosures of which are incorporated herein by reference.

### BACKGROUND

### Field

The present exemplary embodiments relate to a control system of an electric motor which is applied to a vehicle chassis product, and more particularly, to a device and a method for controlling an electric motor which effectively reduce a torque ripple caused by a control frequency of a controller using a notch filter, thereby improving a noise and a vibration characteristic of the vehicle.

### Description of the Related Art

Generally, a command torque of an electric motor used for a chassis product of a vehicle is generated from a higher level of controller. At this time, a current operation point corresponding to the command torque is computed and input to a current controller. At this time, a processing amount of the CPU is limited in one cycle so that the above-mentioned operation cannot be used in the same manner as the current controller cycle.

The higher level of controller and an optimal current operation logic having a relatively high CPU load are set to operate at a slower cycle than an operation cycle of the current controller. Consequently, the current controller has a previous value until a next command current is updated.

If the current command is updated, an error of the current controller is momentarily increased so that the current reaches a transient state, which causes a torque ripple. A torque ripple frequency generated at this time is the same as a control frequency of the higher level of controller and generally in the range of hundreds to thousands of hertz.

Such a torque ripple may cause a noise of a chassis product and deteriorate a steering feel. Specifically, noises and vibrations caused by the torque ripple in various chassis products, such as an electric power steering, an electronic brake booster, an electronic stability control device, an active suspension system, and electronic differentials may negatively affect vehicle quietness and driver satisfaction.

### SUMMARY

The present exemplary embodiments may provide a device and a method for controlling an electric motor which place a notch filter for a final output voltage to reduce a current pulsation of a specific frequency component without significantly increasing a load of the CPU, thereby effectively reducing a torque ripple.

The present exemplary embodiments may provide a device and a method for controlling an electric motor which set a center frequency of a notch filter to a control frequency of a controller to selectively reduce a torque ripple generated in the corresponding frequency component, thereby improving noise and vibration characteristics of the vehicle chassis product.

According to an aspect, the present exemplary embodiments may provide a device for controlling an electric motor included in a vehicle chassis, the device comprising: a feed forward voltage generator configured to generate a feed forward voltage in response to a command current received from a controller; a current controller configured to generate a compensation voltage based on difference between the command current and a measured current measured by a current sensor for the electric motor; an adder configured to add the feed forward voltage and the compensation voltage to generate a total voltage command; and a notch filter configured to remove a center frequency component corresponding to a control frequency of the controller from the total voltage command, generated by adding the feed forward voltage and the compensation voltage, to output a motor control voltage command to be applied to the electric motor.

According to another aspect, the present exemplary embodiments may provide a method for controlling an electric motor included in a vehicle chassis, the method comprising: generating a feed forward voltage in response to a command current received from a controller; generating a compensation voltage based on difference between the command current and a measured current measured by a current sensor for the electric motor; adding the feed forward voltage and the compensation voltage to generate a total voltage command; and removing a center frequency component corresponding to a control frequency of the controller from the total voltage command, generated by adding the feed forward voltage and the compensation voltage, to output a motor control voltage command to be applied to the electric motor.

According to still another aspect, the present exemplary embodiments may provide a non-transitory computer-readable storage medium having instructions that, when executed by one or more processors, cause the one or more processors to perform operations comprising: generating a feed forward voltage in response to a command current received from a controller; generating a compensation voltage based on difference between the command current and a measured current measured by a current sensor for an electric motor; adding the feed forward voltage and the compensation voltage to generate a total voltage command; and removing a center frequency component corresponding to a control frequency of the controller from the total voltage command, generated by adding the feed forward voltage and the compensation voltage, to output a motor control voltage command to be applied to the electric motor.

According to the exemplary embodiments, a notch filter is used by means of the device and the method for reducing a torque ripple of an electric motor to reduce a torque ripple without increasing a CPU load which is generated by the controller, thereby improving the entire efficiency of the system.

Further, a torque ripple of a specific frequency component may be selectively reduced through a notch filter which is set to a center frequency which matches the control frequency of the controller, thereby achieving a noise improvement without deteriorating a control performance.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of a device for controlling an electric motor according to the exemplary embodiments;

FIG. 2 is a flowchart illustrating method for controlling an electric motor according to the exemplary embodiments;

FIGS. 3A and 3B are graphs of an anechoic room test result which shows a torque ripple reduction effect according to the related art and the present exemplary embodiments, respectively; and

FIG. 4 is a block diagram of an exemplary computing system.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting”, “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, a device and a method for controlling an electric motor according to exemplary embodiments of the present disclosure will be described with reference to related drawings.

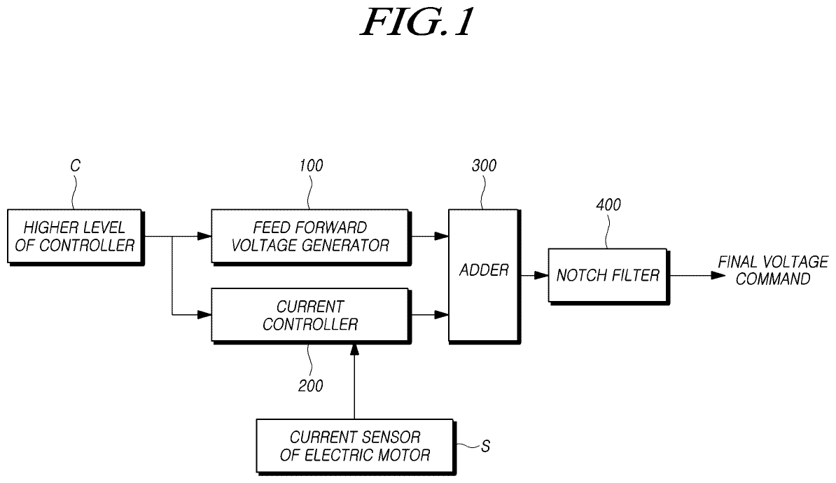

FIG. 1 is a block diagram of a device for controlling an electric motor according to the exemplary embodiments.

A device for controlling an electric motor, and a method for controlling the electric motor, according to the present exemplary embodiment may effectively reduce torque ripple of the electric motor employed in various vehicle chassis products. In particular, a notch filter may be set such that a center frequency matches a control frequency of a controller to selectively reduce torque ripple of a control-frequency component. The device and method may be implemented in a motor control system including the controller and an inverter configured to drive the electric motor, and may be applied to chassis motor-driven assemblies as set forth below. In one embodiment, the electric motor is configured to assist steering, and is provided in an electric power steering (EPS) system. The EPS system may include a steering assistance motor, a reduction mechanism (e.g., a gear set or belt drive) coupled to an output shaft of the steering assistance motor, and a steering mechanism (e.g., a steering column, pinion, and rack) mechanically coupled to the reduction mechanism, wherein the controller drives the motor to generate assist torque.

In one embodiment, the electric motor is included in an electronic brake booster. The electronic brake booster may include a booster motor, a power transmission mechanism (e.g., a gear train and/or a screw mechanism) driven by the booster motor, and a boosting member (e.g., a piston or plunger) actuated by the power transmission mechanism to generate or increase a braking force, wherein the controller drives the booster motor to actuate the boosting member.

In one embodiment, the electric motor is included in a hydraulic pump. The hydraulic pump may include a pump motor, a pump unit (e.g., a gear pump or piston pump) mechanically driven by the pump motor, and a hydraulic circuit fluidly connected to the pump unit to supply pressurized hydraulic fluid, wherein the controller drives the pump motor to control a flow rate and/or pressure of the hydraulic fluid.

In one embodiment, the electric motor is configured to control a damper for an active suspension system. The active suspension system may include a damper control motor coupled to an actuator (e.g., a rotary/linear actuator or a valve actuator) configured to adjust a damping force of a suspension damper, wherein the controller drives the damper control motor to control an actuation amount of the actuator and thereby vary the damping force.

In one embodiment, the electric motor is included in an electronic differential for torque distribution. The electronic differential may include a torque distribution motor coupled to a torque transfer mechanism (e.g., a clutch pack and/or a gear mechanism) configured to vary torque distribution between wheels or axles, wherein the controller drives the torque distribution motor to adjust an engagement force of the torque transfer mechanism.

In one embodiment, the electric motor is included in a transfer case of a four-wheel drive system. The transfer case may include a transfer case motor coupled to a shifting and/or engagement mechanism (e.g., a cam, fork, actuator, gear, and/or clutch) configured to change a drive mode, wherein the controller drives the transfer case motor to engage or disengage the shifting and/or engagement mechanism.

In one embodiment, the electric motor is included in a compressor of an air suspension system. The air suspension system may include a compressor motor coupled to a compressor unit configured to compress air, and an air supply path including a reservoir and one or more valves fluidly connected to air springs, wherein the controller drives the compressor motor to supply compressed air to the air springs.

Accordingly, the device and method may be applied to the above-described motor-driven chassis assemblies to selectively reduce torque ripple of the control-frequency component while maintaining required actuation performance.

The device for controlling an electric motor according to the present exemplary embodiment, as illustrated in FIG. 1, may include a feed forward voltage generator 100, a current controller 200, an adder 300, and a notch filter 400.

The feed forward voltage generator 100 serves to generate a feed forward voltage in response to a command current received from a controller C applied to the chassis product. The feed forward voltage generator 100 may previously determine and generate a basic voltage required by an electric motor based on a model parameter and a command current of the electric motor. This may reduce a burden of the current controller 200 and improve a control responsibility. The controller C may be implemented as a software module which takes charge of a control algorithm to control a motor (electric motor) in an ECU of various chassis products, such as an electric power steering system, an electronic brake booster, an electronic vehicle stability control device, an active suspension system, or an electronic differential.

The current controller 200 serves to generate a compensation voltage based on a difference between the command current and a measured current measured by the current sensor for the electric motor. The current controller 200 may be generally configured by a proportional-integral controller (PI controller) or a proportional integral derivative controller (PID controller) and compensate for a current error to generate a compensation voltage which allows the electric motor to accurately follow the command current.

The adder 300 serves to add the feed forward voltage generated in the feed forward voltage generator 100 and the compensation voltage generated in the current controller 200 to generate a total voltage command. The adder 300 simply adds two voltage signals to generate a basic voltage command to be applied to the electric motor.

The notch filter 400 is a core component of the exemplary embodiment of the present disclosure and serves to remove a center frequency component corresponding to a control frequency of the controller from the total voltage command generated in the adder 300 to output a motor control voltage command to be applied to the electric motor.

The notch filter 400 may be set to a center frequency which matches the control frequency of the controller to selectively reduce a torque ripple of the corresponding frequency component. For example, if the operation frequency of the controller is 1 kHz, the center frequency of the notch filter 400 is also set to 1 kHz to effectively remove the torque ripple generated at the frequency component of 1 kHz.

A transfer function [H(s)] of the notch filter 400 may be represented by the following [Equation 1].

$$H ( s ) = ( {s}^{2} + 2 {ζ}_{1} {ω}_{n} s + {ω}_{n}^{2} ) / ( {s}^{2} + 2 {ζ}_{2} {ω}_{n} s + {ω}_{n}^{2} ) \qquad [ Equation 1 ]$$

[Here, ωₙ is a center frequency (control frequency of controller) and ζ₁ and ζ₂ represent damping ratios of a zero point and a peak point. Generally, ζ₁<ζ₂ is set so that it is designed to have a notch characteristic at the center frequency.]

The feed forward voltage generator 100, the current controller 200, the adder 300, and the notch filter 400 may be implemented by an electronic control unit (ECU) including a micro processor, a memory, an input/output interface, and a communication module and the ECU may be configured by a physical hardware device which is connected to the electronic components, such as a semiconductor chip, a resistor, or a capacitor mounted on a printed circuit board (PCB), through an in-vehicle CAN communication network.

A method for controlling an electric motor using a device for controlling an electric motor according to the present exemplary embodiment configured by the above-described components will be described.

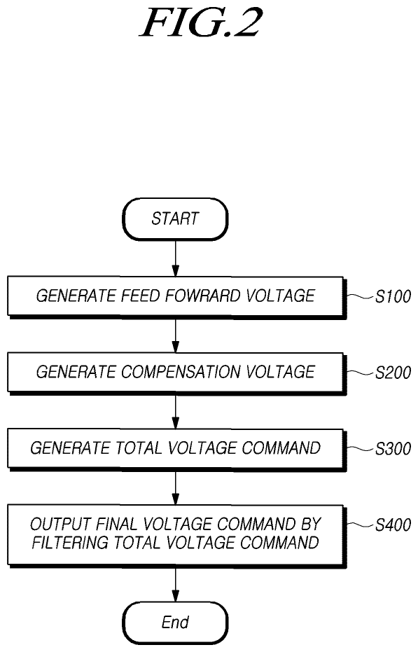

FIG. 2 is a flowchart illustrating a method for controlling an electric motor according to the exemplary embodiments.

First, the feed forward voltage generator 100 generates a feed forward voltage in response to a command current received from a controller C in S100. The feed forward voltage may be determined based on a model parameter and a command current of the electric motor and previously predict and generate a basic voltage required by an electric motor.

Next, the current controller 200 generates a compensation voltage based on the difference between the command current and the measured current measured by the current sensor S for the electric motor in S200. The current controller 200 may generate a voltage for compensating for an error through PI control or PID control with the current error as an input.

Next, the adder 300 adds the feed forward voltage generated in step S100 and the compensation voltage generated in step S200 to generate a total voltage command in S300. The adder 300 simply adds two voltage signals to generate the total voltage command to be applied to the electric motor.

Next, the notch filter 400 removes the center frequency component corresponding to the control frequency (approximately, 1 kHz) of the controller from the total voltage command generated in step S300 to output a motor control voltage command to be applied to the electric motor in S400. The notch filter 400 is set to a center frequency which matches the control frequency of the controller C to selectively reduce a torque ripple of the corresponding frequency component.

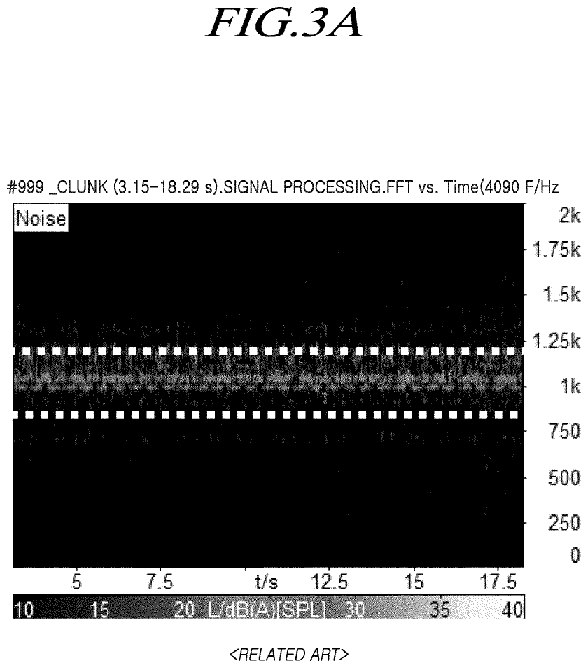

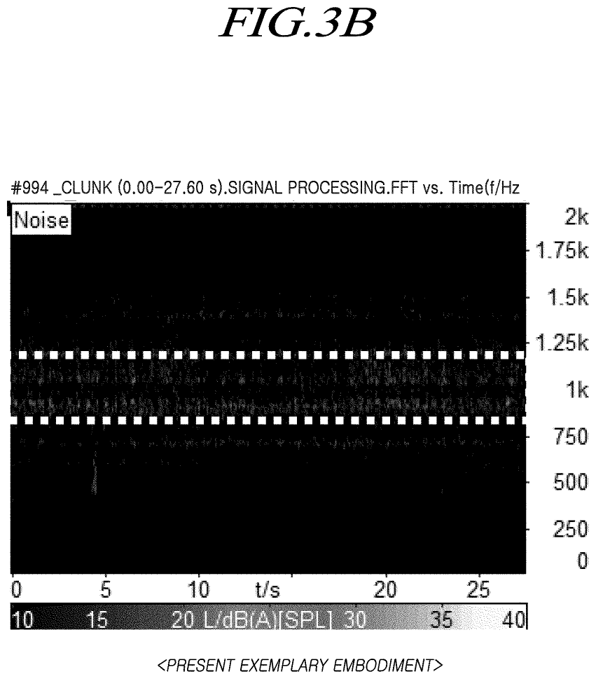

FIGS. 3A and 3B are graphs of an anechoic room test result which shows a torque ripple reduction effect according to the related art and the present exemplary embodiments, respectively.

According to the anechoic room test result, it is confirmed that the position of the notch filter is changed by the method proposed under the condition in which the operation frequency of the controller is 1 kHz to reduce the torque ripple of the specific frequency, thereby significantly improving the noise level. It is confirmed that in the method (FIG. 3A) of the related art, a significant noise is generated in the frequency band of 1 kHz over the entire time period, but after applying the notch filter 400 according to the present exemplary embodiment (FIG. 3B), the noise is significantly reduced in the frequency band of 1 kHz for a longer time period than in the graph of the related art.

In the meantime, although in the above-exemplary embodiments, it has been explained that a notch filter having a fixed parameter is used to reduce the torque ripple of the electric motor, an optimal notch filter parameter may be dynamically determined using an artificial intelligence model. That is, an artificial intelligence model trained by a data set of various operation conditions of the electric motor (a rotation speed, a torque, a temperature, or a load) and an optimal notch filter parameter (a center frequency, a Q factor, or a damping ratio) corresponding to the operation conditions and a current operation condition of the electric motor is input to the trained artificial intelligence model to acquire an optimal notch filter parameter at which the maximum torque ripple reduction effect is obtained under the corresponding operation condition in real time.

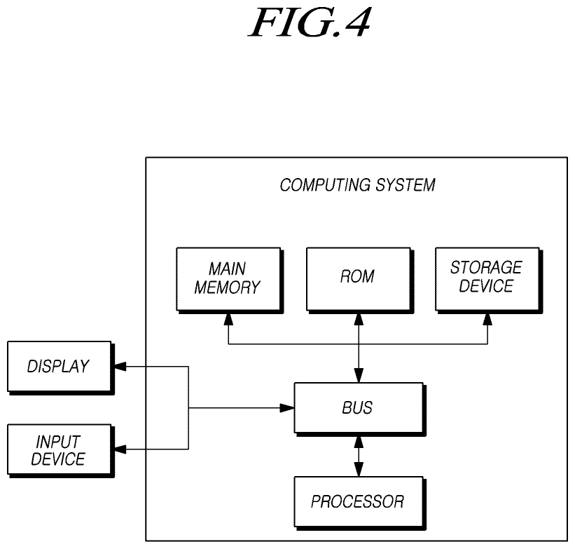

FIG. 4 is a block diagram of an exemplary computing system.

The device for controlling an electric motor according to the present exemplary embodiment may include at least one memory including a computer program instruction and at least one processor which executes the computer program instruction.

For example, at least one processor generates a feed forward voltage in response to a command current received from a controller, generates a compensation voltage based on difference between the command current and the measured current measured by the current sensor for the electric motor, adds the feed forward voltage and the compensation voltage to generate a total voltage command, and removes a center frequency component corresponding to the control frequency of the controller from the total voltage command to output the motor control voltage command to be applied to the electric motor.

At least one processor may be set to a center frequency which matches the control frequency of the controller to selectively reduce a torque ripple of the corresponding control frequency component.

At least one processor may reduce a torque ripple for at least one electric motor, among a steering assistance motor of an electric power steering system, an iBooster motor of an electronic brake booster, a hydraulic pump motor of an electronic vehicle stability control device, a damper control motor of an active suspension system, a torque distribution motor of an electronic differential, a transfer case motor of a four-wheel drive system, and a compressor motor of an air suspension system.

In addition, according to one exemplary embodiment, a non-transitory computer-readable recording medium in which a program for causing a computer to execute the above-described method for controlling an electric motor according to the exemplary embodiments is recorded will also be described. The foregoing description may be omitted to avoid redundant explanation, and in such a case, the omitted content may be substantially identically applied to the following description as well, so long as it does not contradict the technical spirit of the present disclosure.

A non-transitory computer-readable recording medium having recorded thereon a program for causing a computer to execute a method for controlling an electric motor, wherein the program may be configured to perform: generating a feedforward voltage in response to a command current received from a controller; generating a compensation voltage based on a difference between the command current and a measured current measured by a current sensor for the electric motor; adding the feedforward voltage and the compensation voltage to generate a total voltage command; and removing a center-frequency component corresponding to a control frequency of the controller from the total voltage command, generated by adding the feedforward voltage and the compensation voltage, to output a motor control voltage command to be applied to the electric motor.

The computer system or computing device can include or be used to implement the system or its components such as the data processing system. The computing system includes a bus or other communication component for communicating information and a processor or processing circuit coupled to the bus for processing information. The computing system can also include one or more processors or processing circuits coupled to the bus for processing information. The computing system also includes main memory, such as a random access memory (RAM) or other dynamic storage device, coupled to the bus for storing information, and instructions to be executed by the processor. The main memory can be or include the data repository. The main memory can also be used for storing position information, temporary variables, or other intermediate information during execution of instructions by the processor. The computing system may further include a read-only memory (ROM) or other static storage device coupled to the bus for storing static information and instructions for the processor. A storage device, such as a solid state device, magnetic disk or optical disk, can be coupled to the bus to persistently store information and instructions. The storage device can include or be part of the data repository.

The computing system may be coupled via the bus to a display, such as a liquid crystal display or active matrix display, for displaying information to a user. An input device, such as a keyboard including alphanumeric and other keys, may be coupled to the bus for communicating information and command selections to the processor. The input device can include a touch screen display. The input device can also include a cursor control, such as a mouse, a trackball, or cursor direction keys, for communicating direction information and command selections to the processor and for controlling cursor movement on the display. The display can be part of the data processing system, the client computing device or other component.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing.

The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure.

What is claimed is:

1. A device for controlling an electric motor included in a vehicle chassis, the device comprising:
a feed forward voltage generator configured to generate a feed forward voltage in response to a command current received from a controller;
a current controller configured to generate a compensation voltage based on difference between the command current and a measured current measured by a current sensor for the electric motor;
an adder configured to add the feed forward voltage and the compensation voltage to generate a total voltage command; and
a notch filter configured to remove a center frequency component corresponding to a control frequency of the controller from the total voltage command, generated by adding the feed forward voltage and the compensation voltage, to output a motor control voltage command to be applied to the electric motor.

2. The device according to claim 1, wherein the electric motor is configured to assist steering.

3. The device according to claim 1, wherein the electric motor is included in an electronic brake booster.

4. The device according to claim 1, wherein the electric motor is included in a hydraulic pump.

5. The device according to claim 1, wherein the electric motor is configured to control a damper for active suspension.

6. The device according to claim 1, wherein the electric motor is included in an electronic differential for torque distribution.

7. The device according to claim 1, wherein the electric motor is included in a transfer case of a four-wheel drive system.

8. The device according to claim 1, wherein the electric motor is included in a compressor of an air suspension system.

9. The device according to claim 1, wherein the notch filter is set to a center frequency which matches the control frequency of the controller to selectively reduce a torque ripple of the control frequency component.

10. A method for controlling an electric motor included in a vehicle chassis, the method comprising:
generating a feed forward voltage in response to a command current received from a controller;
generating a compensation voltage based on difference between the command current and a measured current measured by a current sensor for the electric motor;
adding the feed forward voltage and the compensation voltage to generate a total voltage command; and
removing a center frequency component corresponding to a control frequency of the controller from the total voltage command, generated by adding the feed forward voltage and the compensation voltage, to output a motor control voltage command to be applied to the electric motor.

11. The method according to claim 10, wherein the electric motor is configured to assist steering.

12. The method according to claim 10, wherein the electric motor is included in an electronic brake booster.

13. The method according to claim 10, wherein the electric motor is included in a hydraulic pump.

14. The method according to claim 10, wherein the electric motor is configured to control a damper for active suspension.

15. The method according to claim 10, wherein the electric motor is included in an electronic differential for torque distribution.

16. The method according to claim 10, wherein the electric motor is included in a transfer case of a four-wheel drive system.

17. The method according to claim 10, wherein the electric motor is included in a compressor of an air suspension system.

18. The method according to claim 10, wherein the removing of the center frequency component comprises setting a center frequency which matches the control frequency of the controller to selectively reduce a torque ripple of the control frequency component.

19. A non-transitory computer-readable storage medium having instructions that, when executed by one or more processors, cause the one or more processors to perform operations comprising:
generating a feed forward voltage in response to a command current received from a controller;
generating a compensation voltage based on difference between the command current and a measured current measured by a current sensor for an electric motor;
adding the feed forward voltage and the compensation voltage to generate a total voltage command; and
removing a center frequency component corresponding to a control frequency of the controller from the total voltage command, generated by adding the feed forward voltage and the compensation voltage, to output a motor control voltage command to be applied to the electric motor.

20. The non-transitory computer-readable storage medium according to claim 19, wherein the removing of the center frequency component comprises setting a center frequency which matches the control frequency of the controller to selectively reduce a torque ripple of the control frequency component.
